(19) United States
(12) Patent Application Publication
(10) Pub. No.: US 2004/0232392 A1
(43) Pub. Date: Nov. 25, 2004

(54) Graphite fine powder, and production method and use thereof

(76) Inventors: Tsutomu Masuko, Omachi-shi (JP); Yoichi Nanba, Omachi-shi (JP); Satoshi Iinou, Omachi-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/482,913

(22) PCT Filed: Jul. 8, 2002
(86) PCT No.: PCT/JP02/06900

Related U.S. Application Data
(60) Provisional application No. 60/304,404, filed on Jul. 12, 2001.

(30) Foreign Application Priority Data
Jul. 9, 2001 (JP) 2001-207262

(51) Int. Cl. H01B 1/04; H01C 1/00; C09C 1/62

(52) U.S. Cl. 252/503; 106/403

(57) ABSTRACT

Graphite fine powder exhibiting excellent electrical conductivity and is suitable for use in, for example, an anti-static application and an electromagnetic wave shielding application, a method for preparing the graphite fine powder, an electrically conductive resin composition using the fine graphite powder having an excellent conductivity and moldability, and a resin molded product using the graphite fine powder having excellent electrical conductivity and strength are provided. The graphite fine powder includes a substance containing a particular element on a part or whole of its surface layer, and the electrically conductive resin composition and the resin molded product are obtained by using the graphite fine powder.

### CROSS-REFERENCE TO RELATED APPLICATION

This application claims the benefit pursuant to 35 U.S.C. §119(e)(1) of U.S. Provisional Application, No. 60/304,404 filed Jul. 12, 2001.

### TECHNICAL FIELD

The present invention relates to graphite fine powder exhibiting excellent electrical conductivity and to a method for producing the powder, and more particularly, relates to graphite fine powder which, when incorporated into a resin, can impart excellent electrical conductivity to the resin, which in turn can provide a resin molded product suitable for use in, for example, an antistatic material or an electromagnetic wave shielding material, as well as to a method for producing the graphite fine powder and to use of the powder.

This application is based on Japanese Patent Application No. 2001-207262, the content of which is incorporated herein by reference.

### BACKGROUND ART

Electrically conductive resin molded products are formed from resin containing electrically conductive fillers dispersed therein, and are employed in, among others, antistatic materials and electromagnetic wave shielding materials.

Electrically conductive fillers include metallic fillers such as gold, silver, copper, palladium, and aluminum; and carbon fillers such as carbon black and graphite.

A metallic filler has an advantage in that it imparts a high electrical conductivity to a resin. However, the mass of a metallic filler is large, and when a metallic filler is kneaded into a resin, the filler raises problems such as wear of screws or dies. Moreover, a metallic filler exhibits low corrosion resistance to acids, etc.

Meanwhile, the mass of a carbon filler is small, and it exhibits high corrosion resistance to acids, etc. In addition, a carbon filler has an advantage in that, when it is added to a resin, kneading of the resultant mixture is carried out easily, without causing wear of screws or dies. However, a carbon filler has a disadvantage in that its electrical conductivity is lower than that of a metallic filler.

Even when graphite fine powder which is sufficiently graphitized by use of a graphitization catalyst such as boron is added to a resin molded product, the electrical conductivity of the molded product cannot be improved to a satisfactory level. Also, when the amount of the graphite fine powder to be added to the resin molded product is increased in order to enhance the electrical conductivity of the molded product, mechanical strength of the molded product is lowered, rendering the molded product practically unusable. Even when a filler mixture of carbon black, graphite fine powder, and vapor grown carbon fiber as disclosed in Japanese Patent Application Laid-Open (kokai) No. Hei 2-77442 is added to a resin molded product, it is difficult to obtain a low resistance on the order of 10⁻²Ω·cm or less. Therefore, when merely a carbon filler is added to a resin molded product, the resultant molded product fails to exhibit a low resistance on the order of 10⁻³Ω·cm or less (i.e., high electrical conductivity), which is required for electrically conductive materials employed in electromagnetic shielding materials or in the electronics field.

When a conventional carbon filler such as carbon black or graphite fine powder is added to a resin molded product, in order to obtain a resistance on the order of 10⁻²Ω·cm; i.e., high electrical conductivity, the amount of the carbon filler added to the molded product must be increased considerably. As a result, moldability is impaired and the resultant molded product exhibits low strength, and thus a limitation is imposed on the use of the molded product. Low electrical conductivity of a carbon filler is attributed to high specific resistance of a carbon filler, the specific resistance being higher than that of a metallic filler, and to high contact resistance between filler particles.

### DISCLOSURE OF INVENTION

An object of the present invention is to attain a considerable reduction in contact resistance between filler particles by enhancing electrical conductivity of graphite fine powder, serving as a filler, and modifying the surface of the graphite fine powder, and to attain considerably enhanced electrical conductivity of a resin molded product containing the filler.

In view of the foregoing, the inventors of the present invention have performed extensive studies on graphite fine powder, a method for producing the graphite fine powder, and a resin molded product containing the graphite fine powder as an electrically conductive filler, and have found that, when a resin molded product incorporates the graphite fine powder containing, at uniform or non-uniform concentration in a portion or the entirety of its surface layer (the surface layer including the outermost surface of a powder particle and having a thickness of about 10 and several nm), a substance containing at least two elements selected from the group consisting of boron, nickel, cobalt, manganese, silicon, magnesium, aluminum, calcium, titanium, vanadium, chromium, iron, copper, molybdenum, tungsten, and zirconium, the resultant molded product exhibits an electrical conductivity higher than that of a resin molded product containing conventional graphite fine powder.

The inventors of the present invention have also found that, when graphite fine powder containing a boride, which is a compound including metal(s) and boron, in its surface layer is added to a resin molded product, the resultant molded product exhibits high electrical conductivity. The reason for the above is considered to be as follows: when a boride is present in the surface layer, particularly on the surface of the graphite fine powder, contact resistance between powder particles is reduced considerably.

The graphite fine powder according to an embodiment of the present invention is not necessarily graphitized completely. Specifically, the degree of the graphitization of the graphite fine powder is sufficient if the powder is graphitized such that the interplanar spacing C₀ (i.e., twice the distance between carbon-lattice layers (d₀₀₂)) as measured through X-ray diffraction is about 0.685 nm or less (i.e., d₀₀₂ is 0.3425 nm or less). The theoretical C₀ value of completely graphitized graphite is known to be 0.6708 μm (i.e., d₀₀₀₂ is 0.3354 nm), and it is considered that the C₀ value of the graphite fine powder according to an embodiment of the present invention does not become smaller than the theoretical C₀ value.

The inventors of the present invention have also found that a resin molded product containing a certain amount of the graphite fine powder of the present invention exhibits considerably improved strength as compared with a resin molded product containing conventional graphite fine powder in the same amount. The reason for this is considered to be as follows: tribological characteristics including sliding property between particles of the graphite fine powder of the present invention are improved, along with wettability of the fine powder with respect to a resin, thereby enhancing dispersibility of the fine powder in the resin.

Accordingly, the present invention provides the following:

1) A graphite fine powder having an average particle size of 0.1 to 100 μm, and comprising at least two elements selected from the group consisting of boron, nickel, cobalt, manganese, silicon, magnesium, aluminum, calcium, titanium, vanadium, chromium, iron, copper, molybdenum, tungsten, and zirconium, the amount of each element being at least 100 mass ppm;

2) A graphite fine powder having an average particle size of 0.1 to 100 μm, and comprising boron and at least one element selected from the group consisting of nickel, cobalt, manganese, silicon, magnesium, aluminum, calcium, titanium, vanadium, chromium, iron, copper, molybdenum, tungsten, and zirconium, the amount of each element being at least 100 mass ppm;

3) A graphite fine powder having an average particle size of 0.1 to 100 μm, characterized by comprising a boride in its surface layer;

4) A graphite fine powder according to 3) above, wherein the amount of boron and a metallic element which forms the boride with boron is at least 100 mass ppm, respectively;

5) A graphite fine powder according to 3) or 4) above, wherein the boride is at least one species selected from the group consisting of iron boride, titanium boride, and nickel boride;

6) A method for producing a graphite fine powder comprising the steps of adding, to carbonaceous powder, at least two species selected from the group consisting of boron, nickel, cobalt, manganese, silicon, magnesium, aluminum, calcium, titanium, vanadium, chromium, iron, copper, molybdenum, tungsten, zirconium, and a compound thereof, the amount of each species being 0.01 to 10% by mass, and subjecting the resultant mixture to heat treatment;

7) A method for producing a graphite fine powder comprising the steps of adding, to carbonaceous powder, boron or a compound thereof; and at least one metal or a compound thereof selected from the group consisting of: nickel, cobalt, manganese, silicon, magnesium, aluminum, calcium, titanium, vanadium, chromium, iron, copper, molybdenum, tungsten, and zirconium, the amount of each species being 0.01 to 10% by mass, and subjecting the resultant mixture to heat treatment;

8) A method for producing a graphite fine powder according to 7) above, wherein the boron compound is boron carbide and/or boron oxide; and at least one of the metal or the compound thereof selected from the group consisting of: nickel, cobalt, manganese, silicon, magnesium, aluminum, calcium, titanium, vanadium, chromium, iron, copper, molybdenum, tungsten, and zirconium, is added to the carbonaceous powder, and the resultant mixture is subjected to heat treatment;

9) A method for producing a graphite fine powder according to 8) above, wherein the boron carbide and/or the boron oxide are added in an amount of 0.02 to 10% by mass with respect to the carbonaceous powder, and the metal and/or the metallic compound are added in an amount of 0.02 to 10% by mass with respect to the carbonaceous powder;

10) A method for producing a graphite fine powder according to any one of 6) through 9) above, wherein the carbonaceous powder is any one selected from the group consisting of natural graphite, artificial graphite, coke, pitch, and mesophase carbon;

11) An electrically conductive resin composition comprising a graphite fine powder as recited in any one of 1) through 5) above;

12) An electrically conductive resin composition according to 11) above, wherein a slurry obtained by mixing the graphite fine powder with polyethylene glycol having a mass average molecular weight of 200 at a ratio of 1:1 has a viscosity of 100 dPa·S or less as measured at 25° C.; and

13) An electrically conductive resin molded product produced through molding of an electrically conductive resin composition as recited in 11) or 12) above.

### BRIEF DESCRIPTION OF DRAWING

FIG. 1 is a schematic vertical cross-sectional view of a cell employed for measuring the volume specific resistance of the graphite fine powder of the present invention.

### BEST MODE FOR CARRYING OUT THE INVENTION

The present invention will next be described in detail.

The raw material of the graphite fine powder of the present invention may be carbonaceous powder such as natural graphite, artificial graphite, coke, mesophase carbon, pitch, wood charcoal, or resin charcoal. Of these, preferred examples are natural graphite; artificial graphite; and coke, mesophase carbon, and pitch, which are easily graphitized through heating. When the graphite fine powder assumes a substantially spherical shape, the powder is easily kneaded in a resin, and fluidity of the powder in the resin is improved. For instance, when the graphite spherical fine powder formed from mesophase carbon is added to a resin, the resultant resin exhibits excellent moldability.

The carbonaceous powder may be pulverized in advance in order to attain a finally required particle size, or may be pulverized after heat treatment. However, preferably, the carbonaceous powder is pulverized in advance in order to attain a required particle size. It is not preferable that the carbonaceous powder is pulverized after heat treatment since the modified surface (e.g., coated boride) is damaged.

The carbonaceous powder may be pulverized by use of, for example, a high-speed rotation pulverizer (a hammer mill, a pin mill, or cage mill), a ball mill (a rotation mill, a vibration mill, or a planetary mill), or a stirring mill (a beads mill, an attritor, a flow-tube mill, or an annular mill). Under certain conditions, an automizer such as a screen mill, a turbo mill, a super micron mill, or a jet mill may be employed.

In consideration of properties and productivity, the average particle size of the carbonaceous powder is preferably 0.1 to 100 μm, more preferably 0.1 to 80 μm. More preferably, the carbonaceous powder has an average particle size of 0.1 to 80 μm and contains substantially no particles having a size of 0.5 μm or less and/or substantially no particles having a size of more than 80 μm; i.e., the carbonaceous powder contains particles having such sizes in a total amount of 5% by mass or less, preferably 1% by mass or less.

In a heat treatment process, at least two species selected from among boron, nickel, cobalt, manganese, silicon, magnesium, aluminum, calcium, titanium, vanadium, chromium, iron, copper, molybdenum, tungsten, zirconium, and a compound thereof, each species having an average particle size of 0.1 to 100 μm, are added to and mixed with carbonaceous powder (raw material powder) having an average particle size of 0.1 to 100 μm, such that the amount of each species is 0.01 to 10% by mass, preferably 0.1 to 10% by mass, on the basis of the entirety of the raw material powder; and the resultant mixture is placed in a graphite-made container having a lid (e.g., a crucible). When the amount of the aforementioned compound is less than 0.01% by mass, the effect of the compound is insufficient, whereas when the amount of the compound exceeds 10% by mass, an effect commensurate with the increased amount is not obtained, and problems such as aggregation of the compound and the carbonaceous powder may arise. In order to have a desired element to be present in graphite powder in an amount of at least 100 mass ppm after heat treatment, more effectively, at least two of the compounds are mixed (for example, when boron is to be present in graphite powder, boron and boron carbide are mixed, or boron carbide and boron oxide are mixed), and the resultant mixture is added to the carbonaceous powder. The reason for the above is as follows: when a mixture of substances having different melting points and boiling points is employed, variation of the temperature in a furnace during heat treatment can be reduced.

Examples of compounds used for obtaining graphite fine powder including boride on its surface are not particularly limited so long as a boride is formed in the surface layer of graphite fine powder. However, preferably, boron carbide, boron oxide, or a mixture thereof having an average particle size of 0.1 to 100 μm; and a metal or a metallic compound having an average particle size of 0.1 to 100 μm are added to raw material powder having an average particle size of 0.1 to 100 μm, and the resultant mixture is placed in, for example, a graphite-made container, followed by heat treatment. Preferred examples of the metal and the metallic compounds include metals which form a boride, such as nickel, cobalt, manganese, magnesium, aluminum, calcium, titanium, vanadium, chromium, iron; and compounds of these metals. The amount of boron carbide, boron oxide, or a mixture thereof added to the raw material powder is preferably 0.01 to 10% by mass on the basis of the entirety of the raw material powder, and the amount of a metal or a metallic compound added to the raw material powder is preferably 0.01 to 10% by mass on the basis of the entirety of the raw material powder. When the addition amount is less than 0.01% by mass, a boride fails to be formed sufficiently in the surface layer of graphite fine powder, whereas when the addition amount exceeds 10% by mass, powder particles aggregate. Preferably, a highly hermetic graphite-made container is employed in order to prevent leakage of evaporated metal and boron components from the container.

The term “boride” collectively refers to compounds formed from a metallic element and boron, and borides having various compositions and structures are known. Borides are represented by the following formulas: MBₙ (n=1, 2, 4, 6, 10, or 12), M₂B, M₂B_{5, M}₃B₂, M₃B₄, etc. (wherein M represents a metallic element). No particular limitation is imposed on the composition and structure of a boride, so long as the boride is reliably present in the surface layer of graphite fine powder. Examples of iron boride (ferroboron) include Fe₂B, FeB (α, β), FeB₂, and Fe₂B₅. Examples of nickel boride include NiB and Ni₂B. Examples of molybdenum boride include MoB, Mo₂B, MoB₂, and Mo₂B₅.

In order to carry out heat treatment, it is preferable that the graphite-made container containing a mixture of the raw material is heated in an atmosphere of an inert gas such as argon, nitrogen, or helium. The furnace employed for heat treatment may be a typical graphitization furnace such as an Acheson furnace or a high-frequency induction heating furnace. Heat treatment is preferably carried out at 2,000° C. or higher and at a temperature such that the aforementioned added substance or a generated boride is not evaporated and lost. The heating temperature is preferably about 2,000 to about 2,500° C. During heat treatment, graphitization of the raw material which has not been graphitized proceeds. In the present invention, it is more effective if the aforementioned added substance serves as a graphitization catalyst. When heat treatment is carried out at 2,500° C. or higher; for example, at 2,500 to 3,200° C., graphitization of graphite fine powder advantageously proceeds, but a substance formed on the surface of the fine powder is evaporated and reduced.

Preferably, the resultant graphite fine powder after the heat treatment is not subjected to any treatment such as pulverization, so that damage to the surface of the sample is prevented.

Any resin or resin composition may be employed in an electrically conductive resin composition containing the graphite fine powder of the present invention, so long as a conventional carbon filler can be incorporated into the resin or resin composition. As used herein, the term “resin” refers to a thermoplastic resin, a thermosetting resin, a thermoplastic elastomer, or similar substances.

Examples of the thermoplastic resin include polyethylene (PE), polypropylene (PP), polymethylpentene, polybutene, polybutadiene, polystyrene (PS), styrene butadiene resin (SB), polyvinyl chloride (PVC), polyvinyl acetate (PVAc), polymethyl methacrylate (PMMA, acrylic resin), polyvinylidene chloride (PVDC), polytetrafluoroethylene (PTFE), an ethylene-polytetrafluoroethylene copolymer (ETFE), an ethylene-vinyl acetate copolymer (EVA), AS resin (SAN), ABS resin (ABS), an ionomer (IO), AAS resin (AAS), ACS resin (ACS), polyacetal (POM, polyoxymethylene), polyamide (PA, nylon), polycarbonate (PC), polyphenylene ether (PPE), polyethylene terephthalate (PETP), polybutylene terephthalate (PBTP), polyarylate (PAR, U polymer), polysulfone (PSF), polyether sulfone (PESF), polyimide (PI), polyamideimide (PAI), polyphenylene sulfide (PPS), polyoxybenzoyl (POB), polyether ether ketone (PEEK), polyether imide (PEI), cellulose acetate (CAB), and cellulose acetate butyrate (CAB). Of these, polyethylene, polypropylene, polyvinyl chloride, polyethyl methacrylate, polytetrafluoroethylene, and an ethylene-polytetrafluoroethylene copolymer are preferred.

Examples of the thermosetting resin include phenol resin (PF), amino resin, urea resin (UF), melamine resin (MF), benzoguanamine resin, unsaturated polyester (UP), epoxy resin (EP), diallyl phthalate resin (allyl resin) (PDAP), silicone (SI), polyurethane (PUR), and vinyl ester resin. Of these, phenol resin, unsaturated polyester resin, epoxy resin, and vinyl ester resin are preferred.

Examples of the thermoplastic elastomer include styrene-butadiene elastomer (SBC), polyolefin elastomer (TPO), urethane elastomer (TPU), polyester elastomer (IPEE), polyamide elastomer (TPAE), 1,2-polybutadiene (PB), polyvinyl chloride elastomer (TPVC), and an ionomer (IO). Of these, polyolefin elastomer, polyamide elastomer, polyester elastomer, and an ionomer are preferred.

Since required properties of the electrically conductive resin composition, including resin moldability, strength of a resin molded product produced from the composition, and electrical conductivity, are varied in accordance with use of the composition, the type of a resin added to the electrically conductive resin composition and the amount of the graphite fine powder added to the composition may be appropriately determined in accordance with use of the composition.

In order to improve hardness, strength, electrical conductivity, moldability, durability, weather resistance, water resistance, etc., if desired, the electrically conductive resin composition of the present invention may contain additives such as glass fiber, carbon fiber, a UV stabilizer, an antioxidant, an anti-foaming agent, a leveling agent, a mold release agent, a lubricant, a water repellent agent, a thickener, a low-shrinking agent, and a hydrophilicity-imparting agent.

No particular limitation is imposed on the molding method for the electrically conductive resin composition of the present invention, and any molding technique may be employed, including compression molding, transfer molding, injection molding, injection compression molding, extrusion molding, and blow molding. Alternatively, an application method such as screen printing may be employed.

The resultant molded product exhibits excellent electrical conductivity, and is useful as, for example, an antistatic material or an electromagnetic wave shielding material employed in various parts of electronic equipment, electric machines, machines, vehicles, etc. The molded product may be employed in printing resistor substrates, planar heating elements, condensation sensors, antistatic paint, shielding paint, and electrically conductive adhesives.

### EXAMPLES

The present invention will next be described in more detail by way of Examples, which should not be construed as limiting the invention thereto.

(Electrical Conductivity Measurement Method)

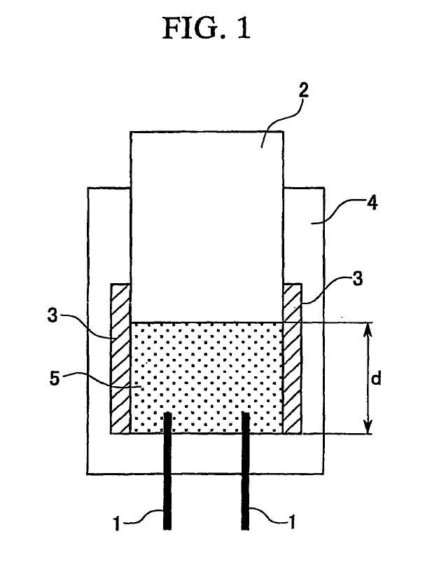

A powder sample to be measured is placed in a resin-made container shown in FIG. 1; pressure is applied to the sample along a vertical direction by use of a compression rod; current is caused to flow through the sample under a constant pressure; voltage between voltage measurement terminals provided in the powder sample is recorded; and the specific resistance of the sample is calculated on the basis of the cross-sectional area of the container and the distance between the terminals. The specific resistance varies with pressure application conditions, and becomes high under low pressure. However, under application of a certain pressure or more, the specific resistance of the sample becomes substantially constant, regardless of pressure application conditions. In the Examples, the volume specific resistance (may be referred to as “compressed specific resistance”) of the sample as measured at 2 MPa is employed for the purpose of comparison.

In the Examples, a resin-made cell 4 as shown in FIG. 1 is employed for measuring volume specific resistance. The cell 4 has a plane area of (1×4) cm2 and a depth of 10 cm. The cell 4 includes copper current terminals 3 for causing current to flow through a powder to be measured 5; voltage measurement terminals 1; and a compression rod 2 for compressing the powder. A certain amount of powder is placed in the cell, and pressure is applied to the powder from above by use of the compression rod 2, to thereby compress the powder.

A continuous current of 0.1 A is caused to flow through the powder while the pressure is measured. When pressure reaches 2 MPa, voltage (E) V between the two voltage measurement terminals 1 (distance between the terminals: 2.0 cm), which are provided through the bottom of the cell, is recorded, and resistance (R) Ω·cm is calculated on the basis of the following formula.

R=(E/0.1)×D (cm²)/2 (cm) (Ω·cm)

(wherein D represents the cross-sectional area of the powder in the direction of current application (depth×width)=10d)

### Example 1

### Iron-boride-coated Graphite Fine Powder

B₄C powder (product of Denki Kagaku Kogyou K. K.) (average particle size: 10 μm) (0.5% by mass), and ferric oxide (Fe₂O₃) powder (average particle size: 1 μm) (0.5% by mass) were added to mesophase carbon KMFC (product of Kawasaki Steel Corporation, average particle size: 20 μm) (100% by mass), and then mixed together. The resultant mixture sample was placed in a graphite-made container having a lid, and the container was placed in an Acheson furnace together with powdery coke. After the inner atmosphere of the furnace was replaced by Ar gas, the container was heated to 2,300° C. over five hours through application of electricity. Thereafter, the container was left to cool for three days, to thereby yield “KMFC-FEB.” Table 1 shows the C₀ value of the resultant fine powder as measured through X-ray diffraction, the amount of a metallic component contained in the powder as measured through fluorescence X-ray analysis, and the compressed specific resistance of the powder. XRD (X-ray diffraction pattern) revealed that iron boride (i.e., a boride) was present in the powder.

### Comparative Example 1

### Untreated Graphite Fine Powder

KMFC (product of Kawasaki Steel Corporation, average particle size: 20 μm) was placed in a graphite-made container having a lid, and the container was placed in an Acheson furnace together with powdery coke. After the inner atmosphere of the furnace was replaced by Ar gas, the container was heated to 2,500° C. over five hours through application of electricity. Thereafter, the container was left to cool for three days, to thereby yield “untreated KMFC.” Table 1 shows the C₀ value of the resultant fine powder as measured through X-ray diffraction, the amount of a metallic component contained in the powder as measured through fluorescence X-ray analysis, and the compressed specific resistance of the powder.

### Comparative Example 2

### Silicon-containing Graphite Fine Powder

SiC powder (average particle size: 10 μm) (4% by mass) was added to KMFC (100% by mass), and mixed together. The resultant mixture sample was placed in a graphite-made container having a lid, and the container was placed in an Acheson furnace together with powdery coke. After the inner atmosphere of the furnace was replaced by Ar gas, the container was heated to 2,300° C. over five hours through application of electricity. Thereafter, the container was left to cool for three days, to thereby yield “KMFC-Si.” Table 1 shows the C₀ value of the resultant fine powder as measured through X-ray diffraction, the amount of a metallic component contained in the powder as measured through fluorescence X-ray analysis, and the compressed specific resistance of the powder.

### (Example 2)

### Iron-boride-coated Graphite Fine Powder

B₄C powder (average particle size: 10 Aim) (3% by mass) and ferric oxide (Fe₂O₃) powder (average particle size: 1 μm) (3% by mass) were added to UFG30 (artificial graphite fine powder, product of Showa Denko K. K., average particle size: 10 μm) (100% by mass), and then mixed together. The resultant mixture sample was placed in a graphite-made container having a lid, and the container was placed in an Acheson furnace together with packing coke. After the inner atmosphere of the furnace was replaced by Ar gas, the container was heated to 2,200° C. over five hours through application of electricity. Thereafter, the container was left to cool for three days, to thereby yield “UFG30-FEB.” Table 1 shows the C₀ value of the resultant fine powder as measured through X-ray diffraction, the amount of a metallic component contained in the powder as measured through fluorescence X-ray analysis, and the compressed specific resistance of the powder. XRD (X-ray diffraction pattern) revealed that iron boride (i.e., a boride) was present in the powder.

### Example 3

### Titanium-boride-coated Graphite Fine Powder

B₄C powder (average particle size: 10 μm) (2% by mass) and titanium oxide (TiO₂) powder (average particle size: 1 μm) (2% by mass) were added to UFG30 (100% by mass), and then mixed together. The resultant mixture sample was placed in a graphite-made container having a lid, and the container was placed in an Acheson furnace together with powdery coke. After the inner atmosphere of the furnace was replaced by Ar gas, the container was heated to 2,100° C. over five hours through application of electricity. Thereafter, the container was left to cool for three days, to thereby yield “UFG-TIB.” Table 1 shows the C₀ value of the resultant fine powder as measured through X-ray diffraction, the amount of a metallic component contained in the powder as measured through fluorescence X-ray analysis, and the compressed specific resistance of the powder. XRD (X-ray diffraction pattern) revealed that titanium boride (i.e., a boride) was present in the powder.

### Comparative Example 3

### Untreated Graphite Fine Powder

UFG30 (artificial graphite fine powder, product of Showa Denko K. K., average particle size: 10 μm) was employed as an untreated sample “untreated UFG.” Table 1 shows the C₀ value of the fine powder as measured through X-ray diffraction, the amount of a metallic component contained in the powder as measured through fluorescence X-ray analysis, and the compressed specific resistance of the powder.

### Example 4

### Iron-boride-coated Graphite Fine Powder

B₄C powder (average particle size: 5 μm) (5% by mass) and ferric oxide (Fe₂O₃) powder (average particle size: 5 μm) (5% by mass) were added to LPC-UL coke (product of Nippon Steel Chemical C₀., Ltd., average particle size: 20 μm) (100% by mass), and then mixed together. The resultant mixture sample was placed in a graphite-made container having a lid, and the container was placed in an Acheson furnace together with powdery coke. After the inner atmosphere of the furnace was replaced by Ar gas, the container was heated to 2,300° C. over five hours through application of electricity. Thereafter, the container was left to cool for three days, to thereby yield “UL-FEB.” Table 1 shows the C₀ value of the resultant fine powder as measured through X-ray diffraction, the amount of a metallic component contained in the powder as measured through fluorescence X-ray analysis, and the compressed specific resistance of the powder. XRD (X-ray diffraction pattern) revealed that iron boride (i.e., a boride) was present in the powder.

### Example 5

### Nickel-boride-coated Graphite Fine Powder

A mixture of B₄C powder (average particle size: 5 μm) and B₂O₃ powder (average particle size: 5 μm) (ratio by mass of B₄C to B₂O₃=1:1) (8% by mass) and nickel carbonate (NiCO₃) powder (average particle size: 5 μm) (8% by mass) were added to LPC-UL coke (100% by mass), and then mixed together. The resultant mixture sample was placed in a graphite-made container having a lid, and the container was placed in an Acheson furnace together with packing coke. After the inner atmosphere of the fuirnace was replaced by Ar gas, the container was heated to 2,500° C. over five hours through application of electricity. Thereafter, the container was left to cool for three days, to thereby yield “UL-NIB.” Table 1 shows the C₀ value of the resultant fine powder as measured through X-ray diffraction, the amount of a metallic component contained in the powder as measured through fluorescence X-ray analysis, and the compressed specific resistance of the powder. XRD (X-ray diffraction pattern) revealed that nickel boride (i.e., a boride) was present in the powder.

### Comparative Example 4

### Untreated Graphite Fine Powder

LPC-UL coke (product of Nippon Steel Chemical Co., Ltd., average particle size: 20 μm) was placed in a graphite-made container having a lid, and the container was placed in an Acheson furnace together with powdery coke. After the inner atmosphere of the furnace was replaced by Ar gas, the container was heated to 2,500° C. over five hours through application of electricity. Thereafter, the container was left to cool for three days, to thereby yield “untreated UL.” Table 1 shows the C₀ value of the resultant fine powder as measured through X-ray diffraction, the amount of a metallic component contained in the powder as measured through fluorescence X-ray analysis, and the compressed specific resistance of the powder.

### Comparative Example 5

### Boron-containing Graphite Fine Powder

B₂O₃ powder (average particle size: 5 μm) (5% by mass) was added to LPC-UL coke (100% by mass), and mixed together. The resultant mixture sample was placed in a graphite-made container having a lid, and the container was placed in an Acheson furnace together with packing coke. After the inner atmosphere of the furnace was replaced by Ar gas, the container was heated to 2,300° C. over five hours through application of electricity. Thereafter, the container was left to cool for three days, to thereby yield “UL-B.” Table 1 shows the C₀ value of the resultant fine powder as measured through X-ray diffraction, the amount of a metallic component contained in the powder as measured through fluorescence X-ray analysis, and the compressed specific resistance of the powder.

### (Comparative Example 6)

### Boron-containing Graphite Fine Powder (reated at High Temperature)

B₂O₃ powder (average particle size: 5 μm) (5% by mass) was added to LPC-UL coke (100% by mass), and mixed together. The resultant mixture sample was placed in a graphite-made container having a lid, and the container was placed in an Acheson furnace together with powdery coke. After the inner atmosphere of the furnace was replaced by Ar gas, the container was heated to 3,000° C. over seven hours through application of electricity. Thereafter, the container was left to cool for three days, to thereby yield “UL-BH.” Table 1 shows the C₀ value of the resultant fine powder as measured through X-ray diffraction, the amount of a metallic component contained in the powder as measured through fluorescence X-ray analysis, and the compressed specific resistance of the powder.

TABLE 1
Electrical conductivity of graphite fine powder

| | | | | Element | Compressed |
|---|---|---|---|---|---|
| | | Heat treatment | C₀ | content | specific resistance |
| | Sample | temperature (° C.) | (nm) | (mass ppm) | (Ω · cm) |
| Ex. 1 | KMFC-FEB | 2300 | 0.673 | Fe . . . 2200 | 9.2 × 10⁻⁵ |
| | | | | B . . . 1800 | |
| Ex. 2 | UFG-FEB | 2200 | 0.673 | Fe . . . 12500 | 7.6 × 10⁻⁵ |
| | | | | B . . . 14200 | |
| Ex. 3 | UFG-TIB | 2100 | 0.673 | Ti . . . 12000 | 4.9 × 10⁻⁵ |
| | | | | B . . . 10900 | |
| Ex. 4 | UL-FEB | 2300 | 0.673 | Fe . . . 15000 | 8.1 × 10⁻⁵ |
| | | | | B . . . 13500 | |
| Ex. 5 | UL-NIB | 2300 | 0.673 | Ni . . . 18000 | 7.6 × 10⁻⁵ |
| | | | | B . . . 22000 | |
| Comp. | Untreated | 2500 | 0.676 | — | 3.3 × 10⁻² |
| Ex. 1 | KMFC | | | | |
| Comp. | KMFC-Si | 2300 | 0.679 | Si . . . 17300 | 1.4 × 10⁻² |
| Ex. 2 | | | | | |
| Comp. | Untreated | — | 0.673 | — | 1.4 × 10⁻² |
| Ex. 3 | UFG | | | | |
| Comp. | Untreated UL | 2500 | 0.673 | — | 2.0 × 10⁻² |
| Ex. 4 | | | | | |
| Comp. | UL-B | 2300 | 0.673 | B . . . 18900 | 1.1 × 10⁻² |
| Ex. 5 | | | | | |
| Comp. | UL-BH | 3000 | 0.671 | B . . . 9800 | 5.5 × 10⁻³ |
| Ex. 6 | | | | | |

(Measurement of Fine Powder-PEG Viscosity)

A slurry containing polyethylene glycol (mass average molecular weight: 200) and the graphite fine powder (ratio by mass=1:1) was prepared, and the viscosity of the slurry (hereinafter referred to as “fine powder-PEG viscosity”) was measured at 25° C. by use of a viscometer (rotation cylindrical viscometer, Viscometer VS-10, product of Rion Co., Ltd.).

(Measurement of Specific Resistance of PP Plate)

A resin molded product containing the graphite fine powder was evaluated as follows.

Polypropylene resin (SMAA410, product of Showa Denko K. K.) was mixed with the graphite fine powder of the present invention (ratio by mass of SMA-410 to graphite fine powder =30: 70), and the resultant mixture was kneaded at 210° C. by use of a pressurized kneader. Subsequently, the resultant mixture was fed to a molding die and subjected to molding at a pressure of 100 MPa, to thereby produce a molded product. The thus-produced resin molded product was subjected to measurement of volume specific resistance (hereinafter referred to as “PP plate specific resistance”) by means of a four-terminal method.

Table 2 shows the results of fine powder-PEG viscosity (dPa-S=10⁻¹ Pa S) and PP plate specific resistance (n-cm) of the samples of Examples 1 through 5 and Comparative Examples 1 through 6.

TABLE 2
Properties of graphite-fine-powder-containing resin

| | | Fine powder-PEG | PP plate specific |
|---|---|---|---|
| | | viscosity | resistance |
| | Sample | (dPa · S) | (Ω · cm) |
| Ex. 1 | KMFC-FEB | 41 | 4.5 × 10⁻⁴ |
| Ex. 2 | UFG-FEB | 91 | 2.5 × 10⁻⁴ |
| Ex. 3 | UFG-TIB | 89 | 1.9 × 10⁻⁴ |
| Ex. 4 | UL-FEB | 75 | 3.6 × 10⁻⁴ |
| Ex. 5 | UL-NIB | 80 | 2.9 × 10⁻⁴ |
| Comp. | Untreated KMFC | 125 | 9.1 × 10⁻² |
| Ex. 1 | | | |
| Comp. | KMFC-Si | 118 | 6.3 × 10⁻² |
| Ex. 2 | | | |
| Comp. | Untreated UFG | 229 | 3.7 × 10⁻² |
| Ex. 3 | | | |
| Comp. | Untreated UL | 148 | 4.0 × 10⁻² |
| Ex. 4 | | | |
| Comp. | UL-B | 128 | 1.8 × 10⁻² |
| Ex. 5 | | | |
| Comp. | UL-BH | 118 | 8.9 × 10⁻³ |
| Ex. 6 | | | |

### Industrial Applicability

As described above, a resin composition is provided which comprises the graphite fine powder of the present invention containing at least two elements selected from the group consisting of boron, nickel, cobalt, manganese, silicon, magnesium, aluminum, calcium, titanium, vanadium, chromium, iron, copper, molybdenum, tungsten, and zirconium exhibits low viscosity, since tribological characteristics and wettability between the resin and the graphite fine powder are excellent. In addition, a resin molded product produced from the composition exhibits high electrical conductivity.

A resin composition which comprises graphite fine powder is provided having an average particle size of 0.1 to 100 μm and containing, in its surface layer, a boride such as iron boride, titanium boride, or a nickel boride exhibits low viscosity, since tribological characteristics and wettability between the resin and the graphite fine powder are excellent. In addition, a resin molded product produced from the composition exhibits high electrical conductivity.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only; the invention is limited and defined only by the following claims and equivalents thereto.

1. A graphite fine powder having an average particle size of 0.1 to 100 μm, comprising:
at least two elements selected from the group consisting of boron, nickel, cobalt, manganese, silicon, magnesium, aluminum, calcium, titanium, vanadium, chromium, iron, copper, molybdenum, tungsten, and zirconium, the amount of each element being at least 100 mass ppm in its surface layer.

2. A graphite fine powder having an average particle size of 0.1 to 100 μm, comprising:
boron and at least one element selected from the group consisting of nickel, cobalt, manganese, silicon, magnesium, aluminum, calcium, titanium, vanadium, chromium, iron, copper, molybdenum, tungsten, and zirconium, the amount of each element being at least 100 mass ppm in its surface layer.

3. A graphite fine powder having an average particle size of 0.1 to 100 μm, comprising a boride in its surface layer.

4. The graphite fine powder as claimed in claim 3, wherein the amount of boron and a metallic element which forms the boride with boron is at least 100 mass ppm, respectively.

5. The graphite fine powder as claimed in claim 3, wherein the boride is at least one species selected from the group consisting of iron boride, titanium boride, and nickel boride.

6. A method for producing a graphite fine powder comprising the steps of:
adding, to carbonaceous powder, at least two species selected from the group consisting of boron, nickel, cobalt, manganese, silicon, magnesium, aluminum, calcium, titanium, vanadium, chromium, iron, copper, molybdenum, tungsten, zirconium, and a compound thereof, the amount of each species being 0.01 to 10% by mass, and subjecting the resultant mixture to heat treatment.

7. A method for producing a graphite fine powder comprising the steps of:
adding, to carbonaceous powder, boron or a compound thereof, and at least one metal or a compound thereof selected from the group consisting of: nickel, cobalt, manganese, silicon, magnesium, aluminum, calcium, titanium, vanadium, chromium, iron, copper, molybdenum, tungsten, and zirconium, the amount of each species being 0.01 to 10% by mass, and subjecting the resultant mixture to heat treatment.

8. The method for producing a graphite fine powder as claimed in claim 7, wherein
the boron compound is boron carbide and/or boron oxide; and at least one metal or the compound thereof selected from the group consisting of: nickel, cobalt, manganese, silicon, magnesium, aluminum, calcium, titanium, vanadium, chromium, iron, copper, molybdenum, tungsten, and zirconium, is added to the carbonaceous powder, and the resultant mixture is subjected to heat treatment.

9. The method for producing a graphite fine powder as claimed in claim 8, wherein the boron carbide and/or the boron oxide are added in an amount of 0.02 to 10% by mass with respect to the carbonaceous powder, and the metal and/or the metallic compound are added in an amount of 0.02 to 10% by mass with respect to the carbonaceous powder.

10. The method for producing a graphite fine powder as claimed in claims 6 or 7, wherein the carbonaceous powder is any one selected from the group consisting of natural graphite, artificial graphite, coke, pitch, and mesophase carbon.

11. An electrically conductive resin composition comprising a graphite fine powder as recited in any one of claims 1 through 3.

12. The electrically conductive resin composition as claimed in claim 11, wherein a slurry obtained by mixing the graphite fine powder with polyethylene glycol having a mass average molecular weight of 200 at a ratio of 1:1 has a viscosity of 100 dPa•S or less as measured at 25° C.

13. An electrically conductive resin molded product produced through molding of an electrically conductive resin composition as claimed in claim 11.
